(19) United States
(12) Patent Application Publication
(10) Pub. No.: US 2005/0179759 A1
(43) Pub. Date: Aug. 18, 2005

(54) Ink jet recording sheet

(76) Inventors: Yoshio Yoshida, Tokyo (JP); Daisuke Imai, Tokyo (JP); Shoichi Endo, Tokyo (JP); Jiro Yoshimura, Tokyo (JP); Noboru Kondo, Tokyo (JP); Kazuhiro Iwasaki, Tokyo (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/506,977

(22) PCT Filed: Mar. 10, 2003
(86) PCT No.: PCT/JP03/02822

(30) Foreign Application Priority Data
Mar. 8, 2002 (JP) 2002-63058
Mar. 28, 2002 (JP) 2002-93335
Feb. 28, 2002 (JP) 2002-93371
Mar. 29, 2002 (JP) 2002-95470

(51) Int. Cl. B41J 2/01

(52) U.S. Cl. 347/105

(57) ABSTRACT

This invention is an inkjet recording sheet having a high gloss cast coating recording layer containing a pigment and a binder comprising mainly polyvinyl alcohol on a support having air permeability, wherein the pigment is a mixture comprising alumina (A) and silica (B) having an average particle diameter of 100˜500 nm, blended in the proportion of A:B=95:5˜50:50 in terms of weight ratio. The silica (B) is preferably a silica to which cationic properties have been imparted, and the alumina (A) is preferably γ-alumina. Due to this, the gloss of a silver halide photograph together with excellent ink absorption properties and print density can be obtained.

### FIELD OF THE INVENTION

This invention relates to an inkjet recording sheet for recording by spraying fine droplets containing a colorant, and more particularly to an inkjet sheet which permits recordings to be made with a high gloss approaching that of a silver halide photograph.

### BACKGROUND OF THE INVENTION

In recent years, due to increasing use of high-speed, high-capacity personal computers and digital cameras, not only offices but increasing numbers of ordinary householders are handling images. With the recent availability of economical, silent inkjet recording systems for outputting images from these apparatuses, it is now desired to obtain an image quality approaching that of a silver halide photograph using this inkjet recording system. Herein, the meaning of “image quality close to that of a silver halide photograph” means that image resolution, color reproducibility and gloss are of the same order as those of a silver halide photograph.

From the viewpoint of hardware, there have been major advances in reducing the inkjet ink droplet size and in improving ink properties. For example, in high image quality inkjet printers referred to as phototype, in addition to the four colors cyan, magenta, yellow and black, high resolution and good color reproducibility can now be obtained by discharging a large amount of these light color inks in the form of ink droplets smaller than those of the prior art. However, to perform recording with the same image quality as that of a silver halide photograph, a suitable recording sheet is required to receive the ink discharged by these printers. Specifically, 1) the sheet must be of such a type that it dries quickly although it receives a large amount of ink, 2) the image must be glossy, 3) the recorded image must be stable with respect to temperature and humidity, and 4) the recorded image must not be easily removed or scratched during handling.

In this case, a high gloss recording sheet which can render a glossy image is required, and an ink-receiving layer of considerable thickness which can receive a large amount of ink thus permitting high resolution with excellent color reproducibility, is required.

Such a high gloss recording sheet may be obtained by cast coating or resin coating. Inventions relating to inkjet recording sheets using the cast coating method are disclosed in Japanese Patent Application Laid-Open (JP-A) No. 62-95285, JP-A No. 63-264391, JP-A No. 02-274587 and JP-A No. 05-59,694 etc. All of these inventions relate to so-called cast coating paper which is obtained by pressing a recording layer comprising a pigment having synthetic silica as its main component and a binder onto a heated mirror surface while the recording layer is still in the wet state, and duplicating the mirror surface on the recording layer surface as it dries to obtain a high gloss surface. However, although the sheet gloss of the sheet obtained by this method is close to that of a silver halide photograph before recording, the gloss of the recorded part after recording was far from that of a silver halide photograph.

Inventions relating to inkjet recording sheets obtained instead by the resin coating method are disclosed in JP-A No. 10-119423, and JP-A No. 11-20306. These inventions describe forming a thermoplastic resin coating layer such as a polyolefin containing a white pigment or the like on the surface of a base paper, and forming a recording layer containing a hydrophilic binder such as polyvinyl alcohol or gelatin and an inorganic pigment on this resin-coated paper. However, in the case of these inkjet recording papers, as a resin coated -paper with no air permeability was used as the support, it took a long time for the paper to dry after the recording layer was coated, and productivity was very low.

In printing applications, sheet gloss is normally the measured light specular reflected at 75°. However, for the gloss of a silver halide photograph, there is little correlation between 75° gloss and visual observation (image clarity). As a gloss with a higher correlation with visual observation, therefore, the gloss viewed from the perpendicular direction, i.e. the 20° gloss is used. Nevertheless, when this was compared to the gloss of the actual recorded image, the correlation between the 20° gloss and visual observation was still poor.

| | Resin coating IJ paper | | | | | | |
|---|---|---|---|---|---|---|---|
| | Company | Company | Company | Silica 100% cast IJ paper | | | |
| | A | B | C | S1 | S2 | S3 | S4 |
| 20° | 66.3 | 81.6 | 51.5 | 21.3 | 23.8 | 30.8 | 36.9 |
| gloss | | | | | | | |
| (%) | | | | | | | |
| 75° | 99.1 | 100.3 | 98.5 | 79.7 | 79.2 | 82.5 | 81.7 |
| gloss | | | | | | | |
| (%) | | | | | | | |
| Image | 65.4 | 83.0 | 72.1 | 45.3 | 34.0 | 45.8 | 49.2 |
| clarity | | | | | | | |
| (%) | | | | | | | |

As shown above, the image clarity of a silver halide photograph is about 65-85%, and the image clarity of an inkjet cast-coated paper having only silica as pigment is 20-30%.

After performing various experiments to obtain a similar gloss to that of a silver halide photograph with an image recorded by the inkjet recording method, it was found that the difference in the way external features were observed through the glossy surface after recording is a reason for the aforesaid poor correlation. Namely, when for example a window or fluorescent light was observed through a silver halide photograph surface, the outline was clearer than the outline when it was observed through a high gloss inkjet recording surface. By evaluating this property as image clarity, it becomes possible to compare the gloss of a silver halide photograph with the gloss of an inkjet recording sheet.

It is therefore an object of this invention to further improve this technique, and thereby to provide an inkjet recording sheet with the same gloss as that of a silver halide photograph having good ink absorption properties and print density, good recorded image storage properties with respect to temperature and humidity, and good recorded image stability to handling so that the image is not easily removed or scratched.

### SUMMARY OF THE INVENTION

This invention is an inkjet recording sheet comprising a glossy cast-coated recording layer containing a pigment and a binder comprising mainly polyvinyl alcohol on a support having air permeability, wherein the aforesaid pigment is a mixture of alumina (A) and silica (B) having an average particle diameter of 100-500 nm in a weight ratio of A:B=95:5-50:50. The aforesaid silica (B) is preferably a silica to which cationic properties have been imparted, and the alumina (A) is preferably γ-alumina. Due to these provisions, a gloss comparable to that of a silver halide photograph, and excellent ink absorption properties and print density can be obtained. Further, by using a polyvinyl alcohol (a) having a polymerization degree of 1000 or less and a saponification degree of 98-99 mol % and (b) a polyvinyl alcohol having a polymerization degree of 1500 or more and a saponification degree of 87-89% as the aforesaid polyvinyl alcohol, the scratch resistance of the recording layer is improved, and it can be given a glossy surface which does not scratch easily and has similar gloss to that of a silver halide photograph. Also, by containing a polyarylamine hydrochloride in the recording layer, image storage properties with respect to temperature and humidity after recording can be improved. Still further, by using a recording layer support formed by one or more underlayers containing a pigment and a binder on at least one side of the aforesaid base paper, and arranging that the pigment of the underlayer contains a synthetic amorphous silica (C) having an absorption oil amount of 200 ml/100 g or more, and ground calcium carbonate (D) wherein particles having a particle diameter of 2 μm or less account for 95 wt % or more, the weight ratio of the synthetic amorphous silica and ground calcium carbonate C:D being 50:50-80:20, adhesive strength between the recording layer and the support can be improved while maintaining good ink absorption properties, and the occurrence of paper edge dust when the recording layer peels during handling or the recording paper is cut, can be reduced.

### DETAILED DESCRIPTION OF THE INVENTION

The inkjet recording sheet of this invention is intended for use in ordinary households, so it must have a high productivity at low cost. Productivity is determined by the drying speed, so in this invention a air-permeable support is used. As long as the support has air permeability and an ink recording layer can be coated thereupon, it may comprise any material such as cloth, non-woven fabric or paper. However, as most practical applications use paper as the support, in the following description the case where paper is the air-permeable support, will be described. Paper used as a air-permeable support may be broadly distinguished as coated paper and non-coated paper, but in this invention, coated paper is preferred for reasons described later.

The raw material pulp for the paper may be a chemical pulp (bleached or unbleached craft pulp from coniferous trees, bleached or unbleached craft pulp from deciduous trees), mechanical pulp (groundwood pulp, thermomechanical pulp, chemithermomechanical pulp) or deinked pulp, any of which may be used alone, or blended together in a desired ratio. The pH of the paper may be acid, neutral or alkaline. The opacity of the paper is preferably increased by containing a filler in the paper. This filler may be suitably selected from among those known in the art such as hydrated silicic acid, white carbon, talc, kaolin, clay, calcium carbonate, titanium oxide or a synthetic resin. Other additives such as a sizing agent, paper reinforcing agent, retention aid, pH regulating agent and various dyes may also be suitably selected and added as internal additives or external additives as required.

The coating layer of the coated paper which can be used as the air-permeable support in this invention is the underlayer of the inkjet recording sheet of this invention, described later.

The recording layer in this invention contains a pigment and polyvinyl alcohol, the pigment preferably being a mixed pigment comprising alumina (A) and silica (B) of average particle diameter 100-500 nm, and these being blended in a weight ratio A:B=95:5-50:50. Consequently, there is rapid ink absorption of both dye-based inks and pigment-based inks, and a high print density can be achieved.

The aforesaid alumina is an aluminum oxide obtained by, for example, sintering aluminum hydroxide. Alumina is known to have many crystalline forms, such as α-alumina, β-alumina and γ-alumina. In order to enhance scratch resistance, γ-alumina is particularly preferred.

The particle diameter and BET specific surface area of the alumina may be suitably selected as required, but the average particle diameter is preferably 1.0-4.0 μm and more preferably 1.5-3.3 μm.

In this invention, the silica blended with the alumina has an average particle diameter of 100-500 nm. However, the average particle diameter of the silica is preferably 120-450 nm, and more preferably 200-400 nm. The average particle diameter of the alumina and silica can be measured by laser diffraction or scattering techniques.

From the viewpoint of stability of the recording layer coating solution, in this invention, silica which has been given cationic properties is preferably used. Normally, silica becomes an anionic slurry when dispersed in water, but if the silica is dispersed in the presence of a cationic substance, the cationic substance binds to the silica surface, and a silica having cationic properties is obtained. When silica to which cationic properties have been imparted is dispersed in water, the slurry has cationic properties. As the surface charge of alumina is normally positive in water, when silica having cationic properties is used, the, alumina can be stably dispersed without concern regarding the order of dispersion or other additives. However, in this invention, ordinary silica having an anionic surface can also be used. In this case, care must be taken regarding dispersion.

When the average particle diameter of alumina and silica decreases, sheet gloss increases, but ink absorption properties tend to decrease. Also, when these average particle diameters increase, ink absorption properties improve but sheet gloss tends to decrease.

In this invention, as described above, the pigment in the recording layer comprises alumina (A) and silica (B) in a proportion of A:B=95:5-50:50 in terms of weight ratio. If the ratio of alumina is larger than the aforesaid range, ink absorption properties decrease. On the other hand, if the ratio of silica is larger than the above range, ink absorption properties improve but sheet gloss decreases, and the print density of recorded images also tends to decrease. In this invention, the proportion used is preferably A:B=(80:20)-(60-40).

Pigments other than alumina and silica may also be used to the extent that they do not interfere with the effect of the invention.

Specific examples of pigments which can be used are aluminum hydroxide, kaolin, talc, calcium carbonate, titanium dioxide, clay and zinc oxide. These may be used alone, or several may be used in combination.

The recording layer in this invention contains polyvinyl alcohol as a binder. By using polyvinyl alcohol, not only is the transparency of the recording layer improved and a gloss approaching that of a silver halide photograph can be obtained, but also print density is improved and the recorded image is clear. Further, by using polyvinyl alcohol as a binder, cationic alumina and anionic silica can be stably dispersed.

The polyvinyl alcohol preferably comprises a mixture of polyvinyl alcohol (a) having a polymerization degree of 1,000 or less and a saponification degree of 98-99 mol %, and (b) polyvinyl alcohol having a polymerization degree of 1,500 or more and a saponification degree of 87-89 mol % used in combination, which maintains a gloss similar to that of a silver halide photograph and improves the scratch resistance of the recording layer. The blending ratio of the polyvinyl alcohols (a) and (b) is preferably 20:80-80:20, but more preferably 30:70-70:30 in terms of weight ratio. If the ratio of the polyvinyl alcohol (b) exceeds 80 wt %, scratch resistance is poorer, and if the weight ratio of the polyvinyl alcohol (a) exceeds 80 wt %, solidification during the coating process tends to be poor.

Further, if the polymerization degree of the polyvinyl alcohol (a) exceeds 1,000, the viscosity stability of the coating solution is poorer, whereas if the polymerization degree of the polyvinyl alcohol (b) is less than 1,500, solidification during the coating process tends to be poor. If the polymerization degree of the polyvinyl alcohol (b) is 2,000 or more, a better solidification state can be maintained.

To the extent that they do not interfere with the purpose of this invention, completely saponified or partially saponified polyvinyl alcohol, carboxylic acid-modified polyvinyl alcohol, silyl-modified polyvinyl alcohol, acetoacetyl group-modified polyvinyl alcohol, polyvinyl acetal resin, starches such as oxidized starch and esterified starch, cellulose derivatives such as carboxymethyl cellulose and hydroxyethylcellulose, polyvinyl pyrrolidone, casein, gelatin, soya bean protein, styrene-acrylic resin and its derivatives, styrene butadiene latex, acrylic emulsion, vinyl acetate emulsion, vinyl chloride emulsion, urethane emulsion, urea emulsion and alkyd emulsion may be used alone or in combination together with the polyvinyl alcohol having the aforesaid specific polymerization degree and saponification degree.

The blending amount of the binder is not particularly limited provided that the required recording layer strength can be obtained, but it is preferably 5 wt parts-30 wt parts, and more preferably 20 wt parts or less, relative to 100 wt parts of pigment. If the blending amount of binder is small, the recording layer strength tends to decrease, and if it is large, ink absorption properties tend to decrease. Also, if the blending amount of polyvinyl alcohol is small, it is difficult to obtain sheet gloss, so the blending amount of the polyvinyl alcohol in the binder component of the recording layer is preferably 30 wt parts or more, and more preferably 50 wt parts or more.

In this invention, the cast coating method is used as a method for making the recording surface of the inkjet recording sheet a glossy surface. In particular, the so-called wet method wherein the coating layer is pressed in intimate contact with a metal drum (cast drum) having a smooth surface which has been heated while the coating layer is still in the wet state, so as to transfer a smooth surface to the formed recording layer, is superior from the viewpoint of gloss, and this method is therefore preferably used in this invention.

It is known that the ink absorption properties of the coated paper manufactured by the cast coating method can be increased by providing an underlayer underneath the cast coating layer. However, if the alumina pigment in the recording layer is excessive, the recording layer strength becomes lower, and even if the underlayer of the prior art is provided, paper edge dust increase when the paper is cut and the recording layer may fall off depending on the method by which it is handled, which is undesirable for practical purposes. These disadvantages are improved if silica is used together with alumina as the coating layer pigment, and polyvinyl alcohol is used as the binder, and in this invention, a layer containing the pigments and binders having the following compositions is preferably further provided as the underlayer of the recording layer. The pigment used in the underlayer is preferably a mixture of synthetic amorphous silica (C) having an oil absorption amount of 200 ml/100 g or more and ground calcium carbonate (D) wherein particles having a particle diameter of 2 μm or less account for 95 wt % or more, the blending weight ratio of the aforesaid (C) and (D) preferably being C:D=50:50-80:20.

Calcium carbonate may broadly be classified into two types. One of these is a natural product (ground calcium carbonate) which is manufactured by physically crushing limestone, and the other is a precipitated product (precipitated calcium carbonate) manufactured by chemically reacting various starting materials. For the underlayer of this invention, among these two types, ground calcium carbonate is used. Ground calcium carbonate has a low oil absorption amount, and a high surface strength can be obtained with a small binder amount, but with ground calcium carbonate alone, the ink absorption capacity required of the underlayer cannot be ensured. Hence, in this invention, a synthetic amorphous silica having an oil absorption amount of 200 ml/100 g or more is used in admixture.

If the proportion of particles having a particle diameter of 2 μm or less in the aforesaid ground calcium carbonate is less than 95%, the specific surface area of the ground calcium carbonate is too small, and the ink absorption capacity of the underlayer is poor. If the proportion of synthetic amorphous silica used to compensate the lack of ink absorption properties is increased, the strength of the underlayer decreases which is undesirable.

Further, as the average particle diameter of the ground calcium carbonate becomes smaller, the strength of the underlayer decreases, the fluidity of the ground calcium carbonate dispersion becomes poorer, the suitability of the underlayer coating solution declines and a uniform coated surface cannot be obtained, which are undesirable effects. Therefore, the average particle diameter of the ground calcium carbonate is preferably 0.1-0.7 μm and the average particle diameter is more preferably 0.2-0.5 μm. The average particle diameters and particle diameter distributions were measured by laser diffraction and scattering techniques.

On the other hand, the oil absorption amount of the synthetic amorphous silica used in the underlayer is preferably 200 ml/100 g or more, but more preferably 300 ml/100 g or more. If the oil absorption amount is less than 200 ml/100 g, the ink absorption properties of the underlayer tend to be poorer.

The ground calcium carbonate and synthetic amorphous silica and ground calcium carbonate may be mixed together after individually dispersing them, or they may be dispersed simultaneously. Alternatively, one pigment may first be dispersed, and the other pigment then added to and dispersed in the first dispersion solution. From the viewpoint of controlling workability and degree of dispersion, it is preferred to individually disperse the synthetic amorphous silica and ground calcium carbonate, and then blend them with the underlayer coating solution. Also, a cationic dispersion agent is preferably used when the dispersion is prepared.

This is because a coating solution having excellent coating properties can still obtained even if a cationic adjuvant such as an ink fixing agent (ink fixing agent or the like) is blended with the underlayer coating solution.

The blending weight ratio of the synthetic amorphous silica (C) and ground calcium carbonate (D) is normally within the range of C:D=50:50-80:20, but more preferably 50:50-70:30. If the synthetic amorphous silica (C) is less than 50 wt %, the ink absorption capacity of the underlayer is poor. Conversely, if it is larger than 80 wt %, the ink absorption capacity of the underlayer increases, but the strength decreases. If the usage amount of binder is increased in order to obtain the required underlayer strength, the viscosity of the coating solution increases so that coating is difficult, and coating unevenness occurs. The cast coating layer is preferably transparent to render the color of the ink sharper, so coating unevenness of the underlayer leads to coating layer unevenness of the inkjet recording sheet which is the final product.

The binder of the underlayer is not particularly limited and may be suitably selected from among those known in the art provided that it is a resin which can form a film after coating and drying. In particular, from the viewpoint of underlayer surface strength, polyvinyl alcohol is preferred as it forms an excellent adhesion to materials having a polar surface such as cellulose fibers and allows underlayer strength to be obtained with a small blending amount. Also, if required, one or more binders known in the art may be added, e.g., starches such as oxidized starch and esterified starch, cellulose derivatives such as carboxymethyl cellulose and hydroxymethylcellulose, gelatin, casein, proteins such as soya bean protein, polyvinylpyrrolidone and its derivatives, acrylic resins, styrene-acrylic resins, vinyl acetate resin, vinyl chloride resin, urea resin, urethane resin, alkyd resin, polyester resin, polycarbonate resin, styrene-butadiene latex, and derivatives thereof.

The blending ratio of pigment and binder in the underlayer is preferably 15-50 wt parts of binder, but more preferably 20-40 wt parts of binder, relative to 100 wt parts of pigment. If a large amount of binder is used in the underlayer, some of the binder remains adsorbed the pigment particles even after coating, so that the ink absorption capacity of the binder layer becomes poorer. Therefore, it is preferred that the binder amount is as small as possible to the extent that the surface strength of the underlayer can be maintained.

The coating amount of the underlayer may be varied depending on the purpose of the inkjet recording sheet, but if the coating amount is increased, the strength of the underlayer falls. In an inkjet recording sheet having a weak underlayer, paper edge dust (cutter edge dust) increases when the paper is cut, which is a serious problem for continuous operation. The dried coating amount of the underlayer has no particular upper limit provided that the aforesaid cutter edge dust does not increase and it does not interfere with handling of the cast coated paper used for inkjet recording which is the final product, but from the viewpoint of productivity of the inkjet recording sheet, it is preferably small, and preferably 20 g/m² or less. However, if the coating amount of the underlayer is decreased too much, the ink absorption capacity of the underlayer is then insufficient, so the coating amount of the underlayer is preferably 4 g/m² or more.

The underlayer may further, if required, be blended with suitable additives known in the art such as a pigment dispersing agent, water retaining agent, thickener, antifoaming agent, preservative; colorant, water resistant agent, wetting agent, plasticizer, fluorescent dye, ultraviolet absorption agent, antioxidant and cationic polymer electrolyte. In order to maintain the strength of the underlayer, these additives are preferably blended in a blending ratio of 20 wt % or less of the total underlayer.

In this invention, the underlayer may be coated on the base paper by any coating device known in the art such as a blade coater, air knife coater, roll coater, curtain coater, kiss coater, bar coater, gate roll coater or gravure coater.

In this invention, to fix the dye component of the ink so as to prevent blurring, a compound having an amino group or ammonium group, and in particular a polymer compound having these groups, is preferably added to the recording layer. Examples of polymer compounds are (co)polymers of diaryl ammonium salt derivatives, arylamine salt copolymers, (meth)acrylates having an ammonium group, (meth) acrylamide (co)polymers, vinyl (co)polymers such as vinyl benzyl ammonium salt (co) polymers, modified polyvinyl alcohols (PVA-), amine/epichlorohydrin addition polymers, dihalide/diamine addition polymers and polyamidines.

In particular, from the viewpoint of preventing discoloration in a high temperature, high humidity environment while maintaining the gloss of the recorded image, and image stability, the recording layer preferably contains a polyarylamine hydrochloride.

A polyarylamine is a water-soluble cationic polymer having one amino group in a side chain, and various types exist in addition to the hydrochloride. Especially, it is thought that when the hydrochloride is used, the colorant component of the ink, the alumina and the polyarylamine hydrochloride form a complex which greatly enhances the fixing properties of the colorant component of the ink. Further, from the viewpoint of enhancing the coating properties of the recording layer coating material, a polyarylamine hydrochloride having a molecular weight of 2,000-10,000 is preferred.

By adding these image stabilizing agents to the recording layer, blurring and discoloration over time due to the water in the ink or high boiling point solvents (glycerine or ethylene glycol derivatives) contained in small quantities in the ink, can be prevented.

When silica with cationic properties is used as a pigment, the coating material of the recording layer in this invention can be manufactured by suitably mixing and dispersing alumina, other pigments, polyvinyl alcohol and other binders, and polyarylamine hydrochloride. However, if ordinary anionic silica is used, a silica and polyvinyl alcohol dispersion must first be prepared, and the alumina or polyamine hydrochloride then mixed and dispersed therewith, or alternatively, the respective dispersions are first prepared, and then carefully mixed and dispersed with adequate stirring.

The means used to coat the coating material thus obtained as a recording layer on the support, may be suitably selected from among methods which use coating devices known in the art such as a blade coater, air knife coater, roll coater, brush coater, kiss coater, squeeze coater, curtain coater, dye coater, bar coater, gravure coater or comma coater.

The coating amount of the recording layer may be adjusted as desired provided that it coats the surface of the base paper and provides sufficient ink absorption properties, but from the viewpoint of both print density and ink absorption properties, it is preferably 5˜30 g/m², and more preferably taking productivity into account, 10˜25 g/m², per side. If 30 g/m² is exceeded, release properties from the cast drum which has a mirror surface decline, and the coated recording layer may stick to the mirror surface of the cast drum. If a large coating amount is required, the aforesaid underlayer is preferably provided between the support and the recording layer.

The coating layer may be transformed into a cast layer by, for example, the direct method, re-wetting method or the solidifying method. When the coating material of this invention is used which contains alumina, silica and polyvinyl alcohol as required components, in order to obtain a gloss similar to that of a silver halide photograph which is the purpose of this invention, the solidifying method is particularly suitable. In this method, a solidifying solution which has the effect of solidifying the binder in the coating layer, i-s applied while the coating layer is still wet, and the semi-gelated coated surface is then pressed against the mirror surface of the heated casting drum via a press roller so that this mirror surface is duplicated on the recording layer surface. By using the solidifying method, minute surface roughness can be reduced, so the gloss of a silver halide photograph is easy to obtain.

In the aforesaid solidifying method, it is preferred to concurrently use boric acid and borates as compounds which have the effect of solidifying the polyvinyl alcohol binder in the coating layer. If borates alone are used in the treatment solution, the solidifying interaction between the borates and the polyvinyl alcohol in the recording layer is too strong, so when the recording layer is pressed in the wet state against the heated mirror surface drum via the press roller and dried, the glossy surface of the drum cannot be sufficiently duplicated on the recording layer.

On the other hand, if boric acid alone is used in the treatment solution, the solidifying interaction between the polyvinyl alcohol in the recording layer and the boric acid is insufficient, so soft, congealed recording layer may stick to the treatment solution roller making it difficult to obtain a properly solidified recording layer. Even if it is attempted to improve the solidification of the polyvinyl alcohol by increasing the boric acid concentration in the treatment solution, as the solubility of boric acid is low, it is difficult to obtain a solidification producing the required hardness.

Due to these reasons, in this invention, it is preferred to use a mixed solution containing borates and boric acid rather than a treatment solution containing either borates or boric acid alone. By so doing, the solidified state of the polyvinyl alcohol is easily adjusted, so an inkjet recording sheet having satisfactory gloss can easily be obtained.

The blending ratio of borates and boric acid in the treatment solution is preferably borates/boric acid=1/4˜2/1 in terms of weight ratio after conversion to the anhydrides. If the blending ratio of borates to boric acid is less than 1/4, solidification of the polyvinyl alcohol in the recording layer is incomplete, and if the blending ratio exceeds 2/1, the polyvinyl alcohol in the recording layer solidifies too hard, so the recording surface may not be able to pick up the glossy surface of the drum, and it may be difficult to obtain a satisfactory glossy surface.

Examples of borates which can be used in this invention are borax, orthoborates, diborates, metaborates, pentaborates and octaborates. The borates used are not particularly limited, but from the viewpoint of cost and ease of procuring them, the use of borax is preferred. The concentrations -of borates and boric acid in the solidifying solution may be suitably adjusted as required, but the total concentration of borates and boric acid in the treatment solution is preferably within the range of 1˜8% in terms of anhydrides. If the concentration of borates and boric acid, and particularly if the concentration of borates, is too high, the solidification of polyvinyl alcohol is excessive, and sheet gloss decreases. Further, if the concentration is high, boric acid tends to separate out from the solidifying solution, and the stability of the solidifying solution becomes poorer.

A release agent may, if required, be added to the recording layer coating solution and treatment solution. The melting point of the added release agent is preferably 90˜150 C., but more preferably 95˜120 C. Within the above range, the melting point of the release agent is almost identical to the metal surface temperature of the mirror finish, so the ability of the release agent is optimized. The release agent is not particularly limited provided that it has the aforesaid properties.

The recording layer coating solution and treatment solution used in this invention may, if required, contain suitable additives such as a pigment dispersant comprising polyethylene wax or a silicone compound, water retaining agent, viscosity increasing agent, antifoaming agent, preservative, colorant, water resistant additive, wetting agent, fluorescent dye, ultraviolet absorption agent and cationic polymer electrolyte.

### EXAMPLES

This invention will now be described in more detail referring to specific examples and comparative examples, but it should be understood that the invention is not to be construed as being limited in any way thereby. Also, unless otherwise specified, “parts” and “%” respectively refer to “wt parts of solid” and “wt % of solids”.

### EXAMPLE 1

Paper was manufactured using a paper machine from a pulp slurry obtained by adding 10 parts of talc, 1 part of aluminum sulfate, 0.1 parts of a synthetic sizing agent and 0.2 parts of a retention aid to a pulp comprising 100 parts of a bleached broadleaf craft pulp (L-BKP) having a beating degree of 285 ml, so as to obtain a support. Starch was coated on the support by a gate roller device so that the dry coating amount was 1.5 g/m² per surface, and simultaneously, the following coating solution A was coated on one surface by the blade method so that the dry coating amount of the underlayer was 8 g/m², thereby obtaining an inkjet recording sheet base paper having a weighting of 190 g/m².

(Preparation of Underlayer Coating Solution A)

80 parts of synthetic amorphous silica (Syloid ED3: Commercial Name of Grace Davison Ltd., oil absorption amount 300 ml/100 g), 20 parts of ground calcium carbonate (Supercoat 95: Commercial Name, manufactured by Fimatech Ltd., average particle diameter 0.67 micrometer, proportion of particles having a particle diameter of 2 μm or less is 95.2%), 25 parts of polyvinyl alcohol (PVA-117: Commercial Name, manufactured by Kuraray Co.,Ltd.), 10 parts of ethylene vinyl acetate copolymer emulsion (Sumicaflex 401: Commercial Name, manufactured by Sumitomo Chemicals Ltd.), 5 parts of cationic ink fixing agent (Polyfix 700: Commercial Name, manufactured by Showa Highpolymers Co.,Ltd.) and 5 parts of cationic sizing agent (Polymaron 360: Commercial Name, manufactured by Arakawa Chemical Industries) were mixed to prepare a color containing 25% solids.

The following coating solution B was then coated by a roll coater on the aforesaid underlayer of the base paper obtained as described above to give a dry coating weight of 20 g/m², and while the recording layer was still wet, the binder in the recording layer was solidified using the following treatment solution (solidifying solution) C. A mirror surface was then duplicated on the recording layer by pressing it against a mirror surface drum heated to 105 C. for 20 seconds via a press roller so as to obtain an inkjet recording sheet of 210 g/m².

(Preparation of Recording Layer Coating Solution B)

90 parts of high purity alumina as pigment (UA-5605: Commercial Name, manufactured by Showa Denko KK, average particle diameter 2.8 μm), 10 parts of silica having cationic properties (Sylojet 703 C: Commercial Name, manufactured by Grace Japan Ltd., average particle diameter 330 nm), 4.5 parts of completely saponified polyvinyl alcohol as binder (PVA-105: Commercial Name, manufactured by Kuraray Co.,Ltd., polymerization degree 500, saponification degree 98.5 mol %), 8.5 parts of partially saponified polyvinyl alcohol (PVA-224: Commercial Name, manufactured by Kuraray Co.,Ltd., polymerization degree 2400, saponification degree 88.0 mol %), 3 parts of polyarylamine hydrochloride having a molecular weight of 3,000 (PAA-HCL-03: Commercial Name, manufactured by Nittoboseki Co.,Ltd.) as polyarylamine hydrochloride and 0.2 parts of antifoaming agent were blended together to prepare a coating solution having a 28% solids concentration. The coating solution was prepared as follows.

A powder of high purity alumina UA-5605 was added a little at a time to a dispersion of Sylojet 703C (concentration 19%) with stirring to obtain a pigment dispersion. To this dispersion were added a 10% solution of PVA-224 and a 20% solution of PVA-105 which were prepared separately. Polyarylamine hydrochloride and an antifoaming agent were then respectively added, and the mixture was stirred to obtain a homogeneous recording layer coating solution.

(Preparation of solidifying solution C)

1.5% of borax (as anhydride) was blended with 3% boric acid and 0.2% of a release agent -(FL-48C: Commercial Name, manufactured by Toho Chemical Industries Co. ,Ltd.), so as to prepare a solidifying solution containing a solids concentration of 4.7%.

### EXAMPLE 2

An inkjet recording sheet was obtained exactly as described in Example 1, except that the blending amount of high purity alumina (UA-5605) used for coating solution B was changed to 75 parts, and the blending amount of silica (Sylojet 703C) was changed to 25 parts.

### EXAMPLE 3

An inkjet recording sheet was obtained exactly as described in Example 1, except that the blending amount of high purity alumina (UA-5605) used for coating solution B was changed to 60 parts, and the blending amount of silica (Sylojet 703C) was changed to 40 parts.

### EXAMPLE 4

An inkjet recording sheet was obtained exactly as described in Example 1, except that the blending amount of high purity alumina (UA-5605) used for coating solution B was changed to 50 parts, and the blending amount of silica (Sylojet 703C) was changed to 50 parts.

### EXAMPLE 5

An inkjet recording sheet was obtained exactly as described in Example 2, except that instead of 10 parts of the cationic silica (Sylojet 703C) used for coating solution B, 25 parts of the anionic silica Snowtex PS-MO (Commercial Name, manufactured by Nissan Chemical Industries Ltd., average particle diameter 150 nm) was blended. The coating material was prepared as follows.

A 20% aqueous dispersion of the high purity alumina UA-5605 was prepared, and a 10% solution of PVA-224 and a 20% solution of PVA-105 which had been prepared separately, were then added in this order and stirred to give a homogeneous dispersion. Next, a dispersion of anionic silica (Snowtex PS-MO) was gradually added with stirring to give a homogeneous solution, and polyarylamine hydrochloride and antifoaming agent were respectively added and stirred to give a homogeneous recording layer coating solution.

### EXAMPLE 6

An inkjet recording sheet was obtained exactly as described in Example 2, except that instead of the aforesaid Sylojet 703C used as the silica for coating solution B, 25 parts of anionic Snowtex MP4540M (Commercial Name, manufactured by Nissan Chemical Industries Ltd., average particle diameter 450 nm) was blended. The coating material was prepared as follows.

A 20% aqueous dispersion of the high purity alumina UA-5605 was repared, and a 10% solution of PVA-224 and a 20% solution of PVA-105 which had been prepared separately, were then added in this order and stirred to give a homogeneous dispersion. Caustic soda was dripped into this dispersion to give a pH of 6, a Snowtex PS-MO dispersion was gradually added while applying a shear in a homogenizer to obtain a homogeneous solution, and polyarylamine hydrochloride and antifoaming agent were respectively added and stirred to give a homogeneous recording layer coating solution.

### EXAMPLE 7

An inkjet recording sheet was obtained exactly as described in Example 2, except that instead of the aforesaid UA-5605 as the alumina used for coating solution B, 75 parts of AKP-G015 (Commercial Name, manufactured by Sumitomo Chemicals Ltd., average particle diameter 2.2 μm) was blended.

### EXAMPLE 8

An inkjet recording sheet was obtained exactly as described in Example 2, except that the blending amount of the completely saponified polyvinyl alcohol (PVA-105: Commercial Name, manufactured by Kuraray Co.,Ltd., polymerization degree 500, saponification degree 98.5 mol %) used for coating solution B was 8.5 parts, and the blending amount of partially saponified polyvinyl alcohol (PVA-224: Commercial Name, manufactured by Kuraray Co.,Ltd., polymerization degree 2400, saponification degree 88.0 mol %) was 4.5 parts.

### EXAMPLE 9

An inkjet recording sheet was obtained exactly as described in Example 2, except that instead of 4.5 parts of completely saponified polyvinyl alcohol (PVA-105: Commercial Name, manufactured by Kuraray Co.,Ltd., polymerization degree 500, saponification degree 98.5 mol %) used for coating solution B, 4.5 parts of completely saponified polyvinyl alcohol (PVA-110: Kuraray Co.,Ltd., polymerization degree 1000, saponification degree 98.5) was blended.

### EXAMPLE 10

An inkjet recording sheet was obtained exactly as described in Example 3, except that instead of 8.5 parts of partially saponified polyvinyl alcohol (PVA-224: Commercial Name, manufactured by Kuraray Co.,Ltd., polymerization degree 2400, saponification degree 88.0 mol %) used for coating solution B, 8.5 parts of partially saponified polyvinyl alcohol (PVA-217: Commercial Name, manufactured by Kuraray Co.,Ltd., polymerization degree 1700, saponification degree 88.0 mol %) was blended.

### EXAMPLE 11

An inkjet recording sheet was obtained as described in Example 3, except that the polyarylamine hydrochloride used for coating solution B was replaced by polyarylamine hydrochloride having a molecular weight of 5,000 (PAA-HCL-05: Commercial Name, manufactured by Nittoboseki Co.,Ltd.). The B type viscosity of the coating solution B2 obtained by this modification was 1960 mPa·sec and coating properties were satisfactory.

### EXAMPLE 12

An inkjet recording sheet was obtained as described in Example 3, except that the polyarylamine hydrochloride used for coating solution B was replaced by polyarylamine hydrochloride having a molecular weight of 1,000 (PAA-HCL-01: Commercial Name, manufactured by Nittoboseki Co.,Ltd.). The B type viscosity of the coating solution B3 obtained by this modification was as high as 3,200 mPa·sec, and although coating was difficult, a coating surface substantially free of unevenness was obtained.

### EXAMPLE 13

An inkjet recording sheet was obtained exactly as described in Example 2, except that the completely saponified polyvinyl alcohol used in coating solution B was not used, and only 13 parts of the partially saponified polyvinyl alcohol (PVA-224: Commercial Name, manufactured by Kuraray Co.,Ltd., polymerization degree 2,400, saponification degree 88.0 mol %) was used.

### EXAMPLE 14

An inkjet recording sheet was obtained exactly as described in Example 3, except that the alumina in the pigment used in coating solution B was 30 parts of high purity alumina (UA-5605: Commercial Name, manufactured by Showa Denko KK, average particle diameter 2.8 μm) and 30 parts of high purity alumina (AKP-G01: Commercial Name, manufactured by Sumitomo Chemicals Ltd., average particle diameter 2.2 μm).

### EXAMPLE 15

An inkjet recording sheet was obtained as described in Example 2, except that the 20 parts of ground calcium carbonate (Supercoat 95) used for the underlayer coating solution in Example 1 was replaced by 20 parts of FMT-UF (Commercial Name, manufactured by Fimatech Ltd., average particle diameter 0.3 μm, proportion of particles of 2 μm or less is 98%).

### EXAMPLE 16

An inkjet recording sheet was obtained exactly as described in example 3, except that the ground calcium carbonate used in the underlayer coating solution A was not used, and 100 parts of synthetic silica (Fineseal X-37: Commercial Name, manufactured by Tokuyama corp.) was used alone together with 5 parts of SB Latex (LX438C: Commercial Name, manufactured by Sumitomo Chemicals Ltd.), 20 parts of polyvinyl alcohol (PVA-117: Commercial Name, manufactured by Kuraray Co.,Ltd.) and 5 parts of a sizing agent (Polymaron 360: Commercial Name, manufactured by Arakawa Chemical Industries Ltd.) blended together to prepare a coating solution having a solids concentration of 20%.

### EXAMPLE 20

An inkjet recording sheet was obtained exactly as described in Example 1, except that the underlayer was formed using the coating solution A used in Example 16, and a coating solution having a solids concentration of 28% was prepared using 70 parts of high purity alumina (AKP-G015: Commercial Name, manufactured by Sumitomo Chemicals Ltd., average particle diameter 2.2 μm) and 30 parts of silica (Sylojet 703C: Commercial Name, manufactured by Grace Japan Ltd., average particle diameter 330 nm) as the pigment of coating solution B of the recording layer, together with 13 parts of polyvinyl alcohol (PVA-224: Commercial Name, manufactured by Kuraray Co.,Ltd.) as binder and 0.2 parts of antifoaming agent.

### COMPARATIVE EXAMPLE 1

An inkjet recording sheet was obtained exactly as described in Example 1, except that the blending amount of alumina used for coating solution B was 100 parts, and silica was not blended therewith.

### COMPARATIVE EXAMPLE 2

An inkjet recording sheet was obtained exactly as described in Example 1, except that the blending amount of alumina used for coating solution B was 30 parts, and the blending amount of silica was 70 parts.

### COMPARATIVE EXAMPLE 3

An inkjet recording sheet was obtained exactly as described in Example 2, except that instead of 10 parts of Sylojet 703C used for coating solution B, 25 parts of Sylojet 710C (Commercial Name, manufactured by Grace Japan Ltd., average particle diameter 1,000 nm) was blended.

### COMPARATIVE EXAMPLE 4

An inkjet recording sheet was obtained exactly as described in Example 2, except that instead of 10 parts of Sylojet 703C used for coating solution B, 25 parts of Snowtex ST-O (Commercial Name, manufactured by Nissan Chemical Industries Ltd., average particle diameter 15 nm) was blended.

### COMPARATIVE EXAMPLE 5

An inkjet recording sheet was obtained as described in Example 17, except that in Example 17, silica was not used as a binder used for coating solution B, and 100 parts of high purity alumina (50 parts of UA-5605 and 50 parts of AKP-G015), and 8 parts of high saponification degree polyvinyl alcohol (PVA-624: Commercial Name, manufactured by Kuraray Co.,Ltd., polymerization degree 2400, saponification degree 98.5 mol %) together with 5 parts of low saponification degree polyvinyl alcohol (Denka Poval B17: Commercial Name, manufactured by Denki Kagaku Industries Ltd., polymerization degree 1700, saponification degree 88.0 mol %) as binder, were used in conjunction.

### COMPARATIVE EXAMPLE 6

An inkjet recording sheet was obtained exactly as described in Example 1, except that coating solution B was prepared from 100 parts of high purity alumina (UA-5605) as pigment, and 13 parts of high polymerization degree, low saponification degree polyvinyl alcohol (PVA-224) as binder used alone without a preservative.

### COMPARATIVE EXAMPLE 7

An inkjet recording sheet was obtained exactly as described in Example 1, except that coating solution B was prepared from 100 parts of high purity alumina (UA-5605) as pigment, and 13 parts of high polymerization degree, low saponification degree polyvinyl alcohol (PVA-105) as binder used alone without a preservative.

The compositions of the inkjet recording sheets obtained in Examples 1˜17 and Comparative Examples 1˜4 are summarized in Table 1 and Table 3. For each sample obtained in these examples and comparative examples, the sheet gloss, release properties of the recording layer and cutter paper edge dust amount as recording layer strength, and print density, ink absorption properties, image clarity, surface scratch resistance after recording and discoloration resistance of the recording at high temperature and high humidity as recording suitability, were measured or evaluated by the following methods. The results are summarized in Table 4 for Examples 1˜8, Table 5 for Examples 9˜17, and Table 6 for Comparative Examples 1˜7. In the tables, the evaluation symbols ⊚˜Δ signify that the composition is practically useful.

(1) Sheet Gloss

The 20 mirror surface gloss of the sheet part measured according to the method described in JIS K7105 was taken as the sheet gloss. A sheet gloss of 15% or more is the gloss of a silver halide photograph.

(2) Recording Layer Strength

a: Visual observation of release state of recording layer when characters are written on the recording layer with a ball pen

⊚: Recording layer is not scratched by ball pen, and writing properties are very good.

◯: Recording layer is hardly scratched by ball pen, and writing properties are good.

Δ: Recording layer is scratched by ball pen, but characters are legible.

X: Recording layer is severely scratched by ball pen so that characters are hardly legible.

b: Cutter Paper Edge Dust

An A4 width sheet (21 cm) was cut 20 times using an NT cutter, and the paper edge dust amount produced was measured.

◯: Paper edge dust amount is 10 mg or less

Δ: Paper edge dust amount is more than 10 mg but less than 20 mg

X: Paper edge dust amount is 20 mg or more

(3) Inkjet Recording Test

A predetermined fill and image pattern were recorded on the samples of Examples 1˜17 using the following two types of inkjet printer, and the samples were evaluated according to the following criteria. Inkjet printer PM-800C: Seiko Epson Ltd (uses dye ink)

a: Print Density

The density of black, cyan, magenta and yellow fill patterns was measured with a Macbeth densitometer (RD 915, Macbeth), and the sum of measured values was taken as the print density.

b: Ink Absorption Properties (Bleeding)

Use was made of the fact that, when absorption properties are poor, the drying of printed ink is incomplete, and color mixing occurs at the boundary with ink which is printed later, leading to discoloration. A pattern having adjacent fill images of red (mixture of magenta and yellow) and green (mixture of cyan and yellow) was printed, and the discoloration (blackening) at the boundary due to bleeding was visually evaluated according to the following criteria.

©: No bleeding observed at all at boundary

◯: Almost no bleeding observed at boundary

Δ: Slight bleeding observed at boundary

X: Serious bleeding observed at boundary

c: Image Clarity

sheet gloss represents the gloss of a silver halide photograph before printing, but the gloss of the paper after image printing is different from that of a photograph. This difference is not only a difference of gloss, but also a difference in the way for example a fluorescent light is reflected by the glossy surface. This reflection was measured as image clarity using an image clarity ester (Model: ICM-IDP, Suga Testing Instruments Ltd.) according to JIS K7105. The MD direction of the paper was measured using a measurement angle of 60 and an optical comb width of 2 mm.

Higher figures indicate higher image clarity with a gloss approaching that of a silver halide photograph. The image clarity of an ordinary glossy silver halide photograph is of the order of 65˜85%.

(4) Handling•Storage

a: Scratch Resistance

The scratches produced at the edges of the second and subsequent sheets when 10 sheets of inkjet recording paper were set in an inkjet printer (MC-2000: Commercial Name, uses Seiko Epson pigment ink), were visually evaluated.

⊚: No scratches observed at all at boundary

◯: Slight scratches observed at boundary

Δ: Scratches observed at boundary

X Serious scratches observed at boundary

b: Recording Stability to Humidity and Temperature

An image of a person (Japan Specifications Association, Standard Image Data N1 Portrait) was printed, left in an environment of 23 C and RH50% for one day, and then exposed to high temperature and high humidity (40 C, RH90%) for 3 day. The color difference before and after treatment was measured. The measurement sites were the forehead skin color part and the background grey part. For the measurements, a color meter (NF999: Commercial Name, manufactured by Nihon Denshoku Ltd.) was used, L*, a*, b* were measured, and ΔE*, Δa* were computed.

The computations of ΔE* and Δa* were performed by the following equations.
ΔE*=((L1*-L2*)2+(a1*-a2*)2+(b1*-b2*)2)0.5
Δa*=a2*-a1*

The measurement values prior to high temperature, high humidity treatment were L1*, a1*, b1*, and the measurement values after high temperature, high humidity treatment were L2*, a2*, b2*.

TABLE 1

| | | Example 1 | | Example 2 | | Example 3 | | Example 4 | | Example 5 | | Example 6 | | Example 7 | |
|---|---|---|---|---|---|---|---|---|---|---|---|---|---|---|---|
| Coat- | Alumina | UA5605 | 80 | UA5605 | 75 | UA5605 | 60 | UA5605 | 50 | UA5605 | 75 | UA5605 | 75 | AKP- | 75 |
| ed | A | | | | | | | | | | | | | G015 | |
| layer | Particle | 2.8μ | | 2.8μ | | 2.8μ | | 2.8μ | | 2.8μ | | 2.8μ | | 2.2μ | |
| | diameter | | | | | | | | | | | | | | |
| | Alumina 2 | — | | — | | — | | — | | — | | — | | — | |
| | Particle | | | | | | | | | | | | | | |
| | diameter | | | | | | | | | | | | | | |
| | silica B | SJ703C | 10 | SJ703C | 25 | SJ703C | 40 | SJ703C | 50 | PS-MO | 25 | MP4540M | 25 | SJ703C | 25 |
| | Particle | 330 nm | | 330 nm | | 330 nm | | 330 nm | | 150 nm | | 450 nm | | 330 nm | |
| | diameter | | | | | | | | | | | | | | |
| | PVA a | PVA105 | 4.5 | PVA105 | 45 | PVA105 | 4.5 | PVA105 | 4.5 | PVA105 | 4.5 | PVA105 | 4.5 | PVA105 | 4.5 |
| | Polymer- | PD500 | | PD500 | | PD500 | | PD500 | | PD500 | | PD500 | | PD500 | |
| | ization | | | | | | | | | | | | | | |
| | degree | | | | | | | | | | | | | | |
| | Saponifi- | SD98.5 | | SD98.5 | | SD98.5 | | SD98.5 | | SD98.5 | | SD98.5 | | SD98.5 | |
| | cation | | | | | | | | | | | | | | |
| | degree | | | | | | | | | | | | | | |
| | PVA b | PVA224 | 8.5 | PVA224 | 85 | PVA224 | 8.5 | PVA224 | 8.5 | PVA224 | 8.5 | PVA224 | 8.5 | PVA224 | 8.5 |
| | Polymer- | PD2400 | | PD2400 | | PD2400 | | PD2400 | | PD2400 | | PD2400 | | PD2400 | |
| | ization | | | | | | | | | | | | | | |
| | degree | | | | | | | | | | | | | | |
| | Saponifi- | SD88 | | SD88 | | SD88 | | SD88 | | SD88 | | SD88 | | SD88 | |
| | cation | | | | | | | | | | | | | | |
| | degree | | | | | | | | | | | | | | |
| | Preserv- | PAA- | 3 | PAA- | 3 | PAA- | 3 | PAA- | 3 | PAA- | 3 | PAA- | 3 | PAA- | 3 |
| | ative | HCL-03 | | HCL-03 | | HCL-03 | | HCL-03 | | HCL-03 | | HCL-03 | | HCL-03 | |
| | Molecular | 3000 | | 3000 | | 3000 | | 3000 | | 3000 | | 3000 | | 3000 | |
| | weight | | | | | | | | | | | | | | |
| Un- | Silica | ED-3 | 80 | ED-3 | 80 | ED-3 | 80 | ED-3 | 80 | ED-3 | 80 | ED-3 | 80 | ED-3 | 80 |

| der | Oil | 300 ml/ | | 300 ml/ | | 300 ml/ | | 300 ml/ | | 300 ml/ | | 300 ml/ | | 300 ml/ | |
|---|---|---|---|---|---|---|---|---|---|---|---|---|---|---|---|
| layer | Absorp- | 100 mg | | 100 mg | | 100 mg | | 100 mg | | 100 mg | | 100 mg | | 100 mg | |
| | tion | | | | | | | | | | | | | | |
| | amount | | | | | | | | | | | | | | |
| | Heavy | SC95 | 20 | SC95 | 20 | SC95 | 20 | SC95 | 20 | SC95 | 20 | SC95 | 20 | SC95 | 20 |
| | calcium | | | | | | | | | | | | | | |
| | carbonate | | | | | | | | | | | | | | |

| Average | 0.67μ | | 0.67μ | | 0.67μ | | 0.67μ | | 0.67μ | | 0.67μ | | 0.67μ | |
|---|---|---|---|---|---|---|---|---|---|---|---|---|---|---|
| particle | | | | | | | | | | | | | | |
| dameter | | | | | | | | | | | | | | |
| 2μ ↓ % | 95.2% | | 95.2% | | 95.2% | | 95.2% | | 95.2% | | 95.2% | | 95.2% | |
| PVA | PVA117 | 25 | PVA117 | 25 | PVA117 | 25 | PVA117 | 25 | PVA117 | 25 | PVA117 | 25 | PVA117 | 25 |
| EVA | Sumika | 10 | Sumika | 10 | Sumika | 10 | Sumika | 10 | Sumika | 10 | Sumika | 10 | Sumika | 10 |
| | 401 | | 401 | | 401 | | 401 | | 401 | | 401 | | 401 | |
| Latex | — | | — | | — | | — | | — | | — | | — | |
| Sizing | Polymaron | 5 | Polymaron | 5 | Polymaron | 5 | Polymaron | 5 | Polymaron | 5 | Polymaron | 5 | Polymaron | 5 |
| agent | 360 | | 360 | | 360 | | 360 | | 360 | | 360 | | 360 | |
| Fixing | PFIX700 | 5 | PFIX700 | 5 | PFIX700 | 5 | PFIX700 | 5 | PFIX700 | 5 | PFIX700 | 5 | PFIX700 | 5 |
| agent | | | | | | | | | | | | | | |

TABLE 2

| | | Example 8 | | Example 9 | | Example 10 | | Example 11 | | Example 12 | |
|---|---|---|---|---|---|---|---|---|---|---|---|
| Coated | Alumina A | UA5605 | 75 | UA5605 | 75 | UA5605 | 60 | UA5605 | 50 | UA5605 | 60 |
| layer | Particle | 2.8μ | | 2.8μ | | 2.8μ | | 2.8μ | | 2.8μ | |
| | diameter | | | | | | | | | | |
| | Alumna 2 | — | | — | | — | | — | | — | |
| | Particle | — | | — | | — | | — | | — | |
| | diameter | | | | | | | | | | |
| | silica B | SJ703C | 25 | SJ703C | 25 | SJ703C | 40 | SJ703C | 50 | SJ703C | 40 |
| | Particle | 330 nm | | 330 nm | | 330 nm | | 330 nm | | 330 nm | |
| | diameter | | | | | | | | | | |
| | PVA a | PVA105 | 8.5 | PVA110 | 4.5 | PVA105 | 4.5 | PVA105 | 4.5 | PVA105 | 45 |
| | Polymerization | PD500 | | PD1000 | | PD500 | | PD500 | | PD500 | |
| | degree | | | | | | | | | | |
| | Saponification | SD98.5 | | SD98.5 | | SD98.5 | | SD98.5 | | SD98.5 | |
| | degree | | | | | | | | | | |
| | PVA b | PVA224 | 4.5 | PVA224 | 8.5 | PVA217 | 8.5 | PVA224 | 8.5 | PVA224 | 8.5 |
| | Polymerization | PD2400 | | PD2400 | | PD1700 | | PD2400 | | PD2400 | |
| | degree | | | | | | | | | | |
| | Saponification | SD88 | | SD88 | | SD88 | | SD88 | | SD88 | |
| | degree | | | | | | | | | | |
| | Preservative | PAA-03 | 3 | PAA-03 | 3 | PAA-03 | 3 | PAA-05 | 3 | PAA-01 | 3 |
| | Molecular | 3,000 | | 3,000 | | 3,000 | | 5,000 | | 1,000 | |
| | weight | | | | | | | | | | |
| Under | Silica | ED-3 | 80 | ED-3 | 80 | ED-3 | 80 | ED-3 | 80 | ED-3 | 80 |
| layer | Oil Absorption | 300 ml/100 mg | | 300 ml/100 mg | | 300 ml/100 mg | | 300 ml/100 mg | | 300 ml/100 mg | |
| | amount | | | | | | | | | | |
| | Heavy calcium | SC95 | 20 | SC95 | 20 | SC95 | 20 | SC95 | 20 | SC95 | 20 |
| | carbonate | | | | | | | | | | |
| | Average particle | 0.67μ | | 0.67μ | | 0.67μ | | 0.67μ | | 0.67μ | |
| | diameter | | | | | | | | | | |
| | 2μ ↓ % | 95.2% | | 95.2% | | 95.2% | | 95.2% | | 95.2% | |
| | PVA | PVA117 | 25 | PVA117 | 25 | PVA117 | 25 | PVA117 | 25 | PVA117 | 25 |
| | EVA | Sumika 401 | 10 | Sumika 401 | 10 | Sumika 401 | 10 | Sumika 401 | 10 | Sumika 401 | 10 |
| | Latex | — | | — | | — | | — | | — | |
| | Sizing agent | Polymaron 360 | 5 | Polymaron 360 | 5 | Polymaron 360 | 5 | Polymaron 360 | 5 | Polymaron 360 | 5 |
| | Fixing agent | PFIX700 | 5 | PFIX700 | 5 | PFIX700 | 5 | PFIX700 | 5 | PFIX700 | 5 |

| | | Example 13 | | Example 14 | | Example 15 | | Example 16 | |
|---|---|---|---|---|---|---|---|---|---|
| Coated | Alumina A | UA5605 | 75 | UA5605 | 30 | UA5605 | 75 | UA5605 | 60 |
| layer | Particle diameter | 2.8μ | | 2.8μ | | 2.8μ | | 2.8μ | |
| | Alumna 2 | — | | AKP-G015 | 30 | — | | — | |
| | Particle diameter | — | | 2.2μ | | — | | — | |
| | silica B | PS-MO | 25 | SJ703C | 40 | SJ703C | 40 | SJ703C | 40 |
| | Particle diameter | 150 nm | | 330 nm | | 330 nm | | 330 nm | |
| | PVA a | — | | PVA105 | 4.5 | PVA105 | 4.5 | PVA105 | 4.5 |
| | Polymerization degree | — | | PD500 | | PD500 | | PD500 | |
| | Saponification degree | — | | SD98.5 | | SD98.5 | | SD98.5 | |
| | PVA b | PVA224 | 13 | PVA224 | 8.5 | PVA224 | 8.5 | PVA224 | 8.5 |
| | Polymerization degree | PD2400 | | PD2400 | | PD2400 | | PD2400 | |
| | Saponification degree | SD88 | | SD88 | | SD88 | | SD88 | |
| | Preservative | PAA-03 | 3 | PAA-03 | 3 | PAA-03 | 3 | PAA-03 | 3 |
| | Molecular weight | 3,000 | | 3,000 | | 3,000 | | 3,000 | |
| Under | Silica | ED-3 | 80 | ED-3 | 80 | ED-3 | 80 | X-37 | 100 |

| | | | | |
|---|---|---|---|---|
| layer | Oil Absorption amount | 300 ml/100 mg | 300 ml/100 mg | 300 ml/100 mg |

| Heavy calcium carbonate | SC95 | 20 | SC95 | 20 | FMT-UF | 20 | — | |
|---|---|---|---|---|---|---|---|---|
| Average particle diameter | 0.67μ | | 0.67μ | | 0.3μm | | — | |
| 2μ ↓ % | 95.2% | | 95.2% | | 98% | | — | |
| PVA | PVA117 | 25 | PVA117 | 25 | PVA117 | 25 | PVA117 | 20 |
| EVA | Sumika 401 | 10 | Sumika 401 | 10 | Sumika 401 | 10 | — | |
| Latex | — | | — | | — | | SBLX 5 | |
| Sizing agent | Polymaron 360 | 5 | Polymaron 360 | 5 | Polymaron 360 | 5 | Polymaron 360 | 5 |
| Fixing agent | PFIX700 | 5 | PFIX700 | 5 | PFIX700 | 5 | PFIX700 | 5 |

TABLE 3

| | | Compalative Ex. 1 | | Compalative Ex. 2 | | Compalative Ex. 3 | | Compalative Ex. 4 | |
|---|---|---|---|---|---|---|---|---|---|
| Coated layer | Alumina A | UA5605 | 100 | UA5605 | 30 | UA5605 | 75 | UA5605 | 75 |
| | Particle diameter | 2.8μ | | 2.8μ | | 2.8μ | | 2.8μ | |
| | Alumina 2 | — | | — | | — | | — | |
| | Particle diameter | | | | | | | | |
| | silica B | — | | SJ703C | 70 | SJ710C | 25 | ST-O | 25 |
| | Particle diameter | — | | 330 nm | | 1000 nm | | 15 nm | |
| | PVA a | PVA105 | 4.5 | PVA105 | 4.5 | PVA105 | 4.5 | PVA105 | 4.5 |
| | Polymerization degree | PD500 | | PD500 | | PD500 | | PD500 | |
| | Saponification degree | SD98.5 | | SD98.5 | | SD98.5 | | SD98.5 | |
| | PVA b | PVA224 | 8.5 | PVA224 | 8.5 | PVA224 | 8.5 | PVA224 | 8.5 |
| | Polymerization degree | PD2400 | | PD2400 | | PD2400 | | PD2400 | |
| | Saponification degree | SD88 | | SD88 | | SD88 | | SD88 | |
| | Preservative | PAA-HCL-03 | 3 | PAA-HCL-03 | 3 | PAA-HCL-03 | 3 | PAA-HCL-03 | 3 |
| | Molecular weight | 3000 | | 3000 | | 3000 | | 3000 | |
| Under layer | Silica | ED-3 | 80 | ED-3 | 80 | ED-3 | 80 | ED-3 | 80 |
| | Oil Absorption amount | 300 ml/100 mg | | 300 ml/100 mg | | 300 ml/100 mg | | 300 ml/100 mg | |
| | Heavy calcium carbonate | SC95 | 20 | SC95 | 20 | SC95 | 20 | SC95 | 20 |
| | Average particle diameter | 0.67μ | | 0.67μ | | 0.67μ | | 0.67μ | |
| | 2μ ↓ % | 95.2% | | 95.2% | | 95.2% | | 95.2% | |
| | PVA | PVA117 | 25 | PVA117 | 25 | PVA117 | 25 | PVA117 | 25 |
| | EVA | Sumika 401 | 10 | Sumika 401 | 10 | Sumika 401 | 10 | Sumika 401 | 10 |
| | Latex | — | | — | | — | | — | |
| | Sizing agent | Polymaron 360 | 5 | Polymaron 360 | 5 | Polymaron 360 | 5 | Polymaron 360 | 5 |
| | Fixing agent | PFIX700 | 5 | PFIX700 | 5 | PFIX700 | 5 | PFIX700 | 5 |

| | | Compalative Ex. 5 | | Compalative Ex. 6 | | Compalative Ex. 7 | |
|---|---|---|---|---|---|---|---|
| Coated layer | Alumina A | UA5605 | 50 | UA5605 | 100 | UA5605 | 100 |
| | Particle diameter | 2.8μ | | 2.8μ | | 2.8μ | |
| | Alumina 2 | AKP-G015 | 50 | — | | — | |
| | Particle diameter | 2.2μ | | | | | |
| | silica B | — | | — | | — | |
| | Particle diameter | — | | — | | — | |
| | PVA a | PVA B17 | 5 | — | | PVA105 | 13 |
| | Polymerization degree | PD1700 | 88 | — | | — | |
| | Saponification degree | | | | | | |
| | PVA b | PVA624 | 8 | PVA224 | 13 | — | |
| | Polymerization degree | PD2400 | | PD2400 | | — | |
| | Saponification degree | SD98 | | SD88 | | | |
| | Preservative | PAA-HCL-03 | 3 | PAA-HCL-03 | 3 | PAA-HCL-03 | 3 |
| | Molecular weight | 3000 | | 3000 | | 3000 | |
| Under layer | Silica | x-37 | 100 | ED-3 | 80 | ED-3 | 80 |

| Oil Absorption amount | 300 ml/100 mg | | 300 ml | | 300 ml | |
|---|---|---|---|---|---|---|
| Heavy calcium carbonate | — | | SC95 | 20 | SC95 | 20 |
| Average particle diameter | | | 0.67μ | | 0.67μ | 95.2% |
| 2μ ↓ % | | | 95.2% | | | |
| PVA | PVA117 | 20 | PVA117 | 25 | PVA117 | 25 |

| | | | | | |
|---|---|---|---|---|---|
| EVA | — | Sumika 401 | 10 | Sumika 401 | 10 |

| | | | | |
|---|---|---|---|---|
| Latex | SBLX | 5 | — | — |

| | | | | | |
|---|---|---|---|---|---|
| Sizing agent | — | Polymaron 360 | 5 | Polymaron 360 | 5 |
| Fixing agent | — | PFIX700 | 5 | PFIX700 | 5 |

TABLE 4

| | | | Example 1 | Example 2 | Example 3 | Example 4 | Example 5 | Example 6 | Example 7 |
|---|---|---|---|---|---|---|---|---|---|
| Sheet | Sheet gloss | 20 degrees(%) | 30 | 29 | 27 | 20 | 31 | 16 | 29 |
| | image clarity | 60 degrees(%) | 82 | 77 | 73 | 65 | 78 | 62 | 80 |
| | Recording layer | Ball-point | ◯ | ◯ | ◯ | ◯ | ◯ | ◯ | ◯ |
| | strength | pen release | | | | | | | |
| | | properties | | | | | | | |
| | | Cutter paper | 4 | 5 | 5 | 6 | 5 | 5 | 5 |
| | | edge dust | | | | | | | |
| Recording | Dye-based inks | Print density | 8.04 | 8.05 | 8.00 | 7.96 | 8.00 | 7.75 | 8.10 |
| suitability | | Ink | ◯ | ⊚ | ⊚ | ⊚ | ◯ | ⊚ | ⊚ |
| | | absorption | | | | | | | |

| | | | | | | | | |
|---|---|---|---|---|---|---|---|---|
| Storage | Color difference of forehead | 3.24 | 3.40 | 3.51 | 3.65 | 3.51 | 3.32 | 3.35 |
| | skin-color part | | | | | | | |
| | Color difference of | 2.60 | 2.72 | 2.73 | 3.00 | 2.80 | 2.63 | 2.70 |
| | background grey part | | | | | | | |
| | Scratch resistance | ◯ | ⊚ | ⊚ | ⊚ | ⊚ | ⊚ | ⊚ |

TABLE 5

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple | ple | ple | ple | ple | ple | ple | ple | ple | ple |
| | | | 8 | 9 | 10 | 11 | 12 | 13 | 14 | 15 | 16 | 17 |
| Sheet | Sheet gloss | 20 degrees(%) | 29 | 32 | 27 | 22 | 25 | 32 | 28 | 30 | 27 | 23 |
| | image clarity | 60 degrees(%) | 77 | 78 | 71 | 64 | 78 | 77 | 74 | 77 | 72 | 70 |
| | Recording | Ball-point pen | ◯ | ◯ | ◯ | ◯ | ◯ | ◯ | ◯ | ◯ | ◯ | ◯ |
| | layer | release | | | | | | | | | | |
| | strength | properties | | | | | | | | | | |
| | | Cutter paper | 5 | 5 | 5 | 6 | 5 | 5 | 5 | 5 | 28 | 25 |
| | | edge dust | | | | | | | | | | |
| Recording | Dye-based | Print density | 7.95 | 8.11 | 7.89 | 7.91 | 8.01 | 8.05 | 8.04 | 8.06 | 7.97 | 7.92 |
| suitability | inks | Ink absorption | ⊚ | ◯ | ⊚ | ⊚ | ⊚ | ◯ | ⊚ | ⊚ | ⊚ | ⊚ |
| | | properties | | | | | | | | | | |

| | | | | | | | | | | | |
|---|---|---|---|---|---|---|---|---|---|---|---|
| Storage | Color difference of forehead | 3.5 | 3.41 | 3.62 | 3.83 | 3.48 | 3.44 | 3.55 | 3.34 | 3.14 | 4.34 |
| | skin-color part | | | | | | | | | | |
| | Color difference of | 2.72 | 2.6 | 2.8 | 3.12 | 2.66 | 2.7 | 2.62 | 2.71 | 2.41 | 3.89 |
| | background grey part | | | | | | | | | | |
| | Scratch resistance | ⊚ | ⊚ | ⊚ | ⊚ | ⊚ | Δ | ⊚ | ⊚ | ⊚ | ⊚ |

TABLE 6

| | | | Compa- | Compa- | Compa- | Compa- | Compa- | Compa- | Compa- |
|---|---|---|---|---|---|---|---|---|---|
| | | | rative | rative | rative | rative | rative | rative | rative |
| | | | Ex. 1 | Ex. 2 | Ex. 3 | Ex. 4 | Ex. 5 | Ex. 6 | Ex. 7 |
| Sheet | Sheet gloss | 20 degrees(%) | 29 | 13 | 9 | 33 | 26 | 30 | 14 |
| | image clarity | 60 degrees(%) | 86 | 50 | 55 | 75 | 82 | 88 | 57 |
| | Recording | Ball-point | ◯ | ◯ | ◯ | ◯ | ◯ | ◯ | Δ |
| | layer | pen release | | | | | | | |
| | strength | properties | | | | | | | |
| | | Cutter paper | 4 | 7 | 6 | 6 | 24 | 5 | 8 |
| | | edge dust | | | | | | | |
| Recording | Dye-based | Print density | 8.06 | 7.70 | 7.53 | 7.98 | 8.10 | 8.12 | 7.9 |
| suitability | inks | Ink | Δ | ⊚ | ⊚ | Δ | X | Δ | ◯ |
| | | absorption | | | | | | | |

| | | | | | | | | |
|---|---|---|---|---|---|---|---|---|
| Storage | Color difference of | 3.1 | 3.88 | 3.6 | 3.55 | 4.5 | 5.12 | 5.02 |
| | forehead skin-color part | | | | | | | |
| | Color difference of | 2.44 | 3.21 | 2.84 | 2.74 | 4.01 | 4.55 | 4.36 |
| | background grey part | | | | | | | |
| | Scratch resistance | ⊚ | ⊚ | ⊚ | ⊚ | ⊚ | X | ◯ |

As can be seen from Tables 4 and 5, it was found that with the red inkjet recording sheets of Examples 1˜17, ink absorption properties, print density and sheet gloss were all well-balanced and satisfactory. On the other hand, as can be seen from Table 6, in Comparative Examples 1, 6, 7 which contain only alumina in the recording layer, print density is a relatively high value, but the ink absorption properties of Comparative Examples 1, 5 which contain the low saponification degree PVA (b) are inadequate, and for Comparative Example 7 which contains only the low polymerization degree, low saponification degree PVA (a), sheet gloss and image clarity are both low. It was found that in Comparative Example 2 wherein the blending ratio of alumina (A) and silica (B) is A:B=30:70 in terms of weight ratio, and in Comparative Example 3 wherein the average particle diameter of silica is 1,000 nm, ink absorption properties are high but sheet gloss is low, and in Comparative Example 4 wherein the average particle diameter of silica is 15 nm, sheet gloss is high but ink absorption properties are extremely poor, and a printed image of satisfactory quality could not be obtained in any of these cases.

### INDUSTRIAL APPLICATIONS OF THE INVENTION

The inkjet recording sheet of this invention offers the gloss of a silver halide photograph, has sufficient ink absorption properties and image density and excellent image stability to temperature and humidity together with excellent scratch resistance during handling, and it is therefore of very high industrial significance.

1. An inkjet recording sheet having a high gloss cast coating recording layer containing a pigment and a binder comprising mainly polyvinyl alcohol on a support having air permeability, wherein said pigment is a mixture comprising alumina (A) and silica (B) having an average particle diameter of 100˜500 nm, blended in the proportion of A:B=95:5˜50:50 in terms of weight ratio.

2. The inkjet recording sheet according to claim 1, wherein the polyvinyl alcohol of said cast coating recording layer comprises the two components, polyvinyl alcohol (a) having a polymerization degree of 1,000 or more and a saponification degree of 98˜99 mol %, and, polyvinyl alcohol (b) having a polymerization degree of 1500 or more and a saponification degree of 87˜89 mol %.

3. The inkjet recording sheet according to claim 1, wherein said cast coating recording layer further comprises a polyarylamine hydrochloride.

4. The inkjet recording sheet according to claim 1, wherein said support has one or more underlayers containing a binder and a pigment on at least one surface of a base paper, said pigment contains synthetic amorphous silica (C) having an oil absorption amount of 200 ml/100 g or more and ground calcium carbonate (D) wherein the particles having a particle diameter of 2 μm or less account for 95 wt % or more, and the weight ratio C:D of this synthetic amorphous silica and ground calcium carbonate is 50:50˜80:20.

5. The inkjet recording sheet according to claim 1, wherein said silica (B) is silica to which cationic properties have been imparted.

6. The inkjet recording sheet according to claim 1, wherein said alumina (A) is γ-alumina.

7. The inkjet recording sheet according to claim 1, wherein the average particle diameter of said alumina (A) is 1.0˜4.0 μm.

8. The inkjet recording sheet according to claim 1, wherein the blending ratio of the pigment and the binder comprising mainly polyvinyl alcohol in said cast coating recording layer is 5˜30 wt parts relative to 100 wt parts of pigment.

9. The inkjet recording sheet according to claim 4, wherein the average particle diameter of said ground calcium carbonate (D) is 0.2˜0.5 μm.

10. The inkjet recording sheet according to claim 4, wherein the blending ratio of the pigment and binder in said underlayer is 15˜50 wt parts relative to 100 wt parts of pigment.

11. The inkjet recording sheet according to claim 1, wherein said cast coating recording layer is a recording layer formed by the wet method.

12. The inkjet recording sheet according to claim 11, wherein said wet method is a method comprising a step having the function of solidifying the binder in the coating layer while the coating layer is still in the wet state.

13. The inkjet recording sheet according to claim 12, wherein said solidifying solution contains boric acid and a borate.
